(19) United States
(12) Patent Application Publication
(10) Pub. No.: US 2020/0353900 A1
(43) Pub. Date: Nov. 12, 2020

(54) AUTOMATED VEHICLE SERVICE NETWORK, METHOD, AND SYSTEM

(71) Applicant: OSMAN YUSUF, HOLLYWOOD PARK, TX (US)

(72) Inventor: OSMAN YUSUF, HOLLYWOOD PARK, TX (US)

(21) Appl. No.: 16/862,707

(22) Filed: Apr. 30, 2020

Related U.S. Application Data
(60) Provisional application No. 62/843,681, filed on May 6, 2019.

(51) Int. Cl. B60S 5/00; G06Q 10/00; G07C 5/08; B60T 17/22; F01M 11/04; B25H 5/00; B25J 9/16

(52) U.S. Cl. CPC B60S 5/00; G06Q 10/20; G07C 5/0841; B25J 9/1697; B60T 17/221; F01M 11/0458; B25H 5/00; G07C 5/0808

(57) ABSTRACT

An automated system, method and network for oil changing and other routine vehicle maintenance using robotics and various cameras and sensors, which is highly efficient, cost effective, and time-saving. Via a network, users can manage, schedule and keep track of their vehicles and related services.

### CROSS REFERENCE TO RELATED APPLICATIONS

This application claims the benefit of U.S. Provisional Application No. 62/843,681 filed on May 6, 2019, which is incorporated herein by reference in its entirety.

### BACKGROUND

This section is intended to introduce the reader to aspects of art that may be related to various aspects of the present disclosure described herein, which are described and/or claimed below. This discussion is believed to be helpful in providing the reader with background information to facilitate a better understanding of the various aspects of the present disclosure described herein. Accordingly, it should be understood that these statements are to be read in this light, and not as admissions of prior art.

Vehicle manufacturers recommend owners and/or operators to have a multitude of checks, services and maintenance performed regularly on their vehicles. These can be performed by either a vehicle service center which specializes in the line of work, or in some cases by the individual owner and/or operator if the operation is not too complex and the person is willing and able. For example, some common vehicle services include oil change and windshield washer fluid replenishment. In addition, some more complex services include checking brake pad wear and remaining life, as well as tire tread wear and remaining life, and eventually replacing worn brake pads and tires. In most cases these services are very time consuming in both planning and actual operation. Vehicle service centers performing such services require advanced notice to schedule an appointment. In addition, these companies typically operate during normal daytime working hours which requires would-be customers to take time off work to bring their vehicle in for an appointment, which in turn incorporates an inherent opportunity cost making the time needed even more valuable. Further, in the ever-increasing competitive nature of the vehicle servicing industry, vehicle service centers are left to try and upsell additional services to customers even though they have not solicited nor in some cases require said additional services, in turn negatively affecting the customer's experience with vehicle service centers as a whole, due to aggressive upselling tactics or simply unwanted advice.

In addition, such service centers tend to generally operate inefficiently with a staff of human operators, who are also prone to various human errors (e.g., incorrect oil/fluids). Furthermore, payment for these aforementioned services are also time consuming as they require the customer to stand in line at a checkout counter in typical retail fashion only to be given a hard copy paper receipt which can be easily misplaced and lost. Equally, history and payment data related to a specific vehicle's prognostics, diagnosis, service and maintenance history is rarely stored electronically for the vehicle owner and/or driver to easily locate and retrieve. All of this data is critical for a multitude of purposes from maintenance planning and scheduling, insurance and future vehicle valuation purposes. The only alternative to using a vehicle service center is to perform the aforementioned services by oneself, which also poses problems associated with opportunity cost as well as other larger initial setup costs to purchase the proper tools needed. In addition, there may be associated disposal costs. For example, oil must be drained into an approved receptacle and delivered to a company providing disposal services, which again may defeat the whole purpose of performing the service by oneself as the eventuality of a third party is inherent.

Fluid replenishing is an even more common task and, in some cases, can be required more often than an oil change, which results in the operator accessing the hood to locate the respective fluid reservoir and physically pour the new fluid into the hole, of which can be a very messy operation even with the use of a funnel, or dangerous if the vehicle engine is still warm from driving.

Hence, what is needed is an automated system, method and network for oil changing and other routine vehicle maintenance that allows users to not only manage, schedule and keep track of their vehicles and related services, but is also highly efficient, cost effective, and time-saving.

### BRIEF DESCRIPTION OF THE DRAWINGS

The following description should be read with reference to the drawings, in which like elements in different drawings are numbered in like fashion. The drawings, which are not necessarily to scale, depict selected embodiments and are not intended to limit the scope of the disclosure. The disclosure may be more completely understood in consideration of the following detailed description of various embodiments in connection with the accompanying drawings, in which:

FIG. 1 illustrates a front view of one non-limiting embodiment of the Automated Vehicle Service (AVS) system of the disclosure described herein, of which is loaded onto a flatbed trailer of semi-truck for rapid deployment and/or relocation.

FIG. 2 illustrates a perspective view of one non-limiting embodiment of the Automated Vehicle Service (AVS) system of the disclosure described herein.

FIG. 3 illustrates a sectional view of one non-limiting embodiment of the Automated Vehicle Service (AVS) system of the disclosure described herein.

FIG. 4 illustrates a sectional view of one non-limiting embodiment of the Automated Vehicle Service (AVS) system of the disclosure described herein.

### DETAILED DESCRIPTION

In the Brief Summary of the present disclosure above and in the Detailed Description of the disclosure described herein, and the claims below, and in the accompanying drawings, reference is made to particular features (including method steps) of the disclosure described herein. It is to be understood that the disclosure of the disclosure described herein in this specification includes all possible combinations of such particular features. For example, where a particular feature is disclosed in the context of a particular aspect or embodiment of the disclosure described herein, or a particular claim, that feature can also be used, to the extent possible, in combination with and/or in the context of other particular aspects and embodiments of the disclosure described herein, and in the disclosure described herein generally.

The embodiments set forth below represent the necessary information to enable those skilled in the art to practice the disclosure described herein and illustrate the best mode of practicing the disclosure described herein. In addition, the disclosure described herein does not require that all the advantageous features and all the advantages need to be incorporated into every embodiment of the disclosure described herein.

In one implementation of the disclosure described herein, a display page may include information residing in the computing device's memory, which may be transmitted from the computing device over a network to a central database center and vice versa. The information may be stored in memory at each of the computing device, a data storage resided at the edge of the network, or on the servers at the central database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., an iPhone®, Android®, Blackberry®, or any “smart phone”), a personal computer, iPad®, server computer, or laptop computer; personal digital assistants (PDAs) such as a Palm-based device or Windows® CE device; a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including Bluetooth®, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also comprise a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, features, options, and/or attributes of the disclosure described herein. For example, the portal can be a web page accessed with a web browser, mobile device application, or any application or software residing on a computing device.

In general, the AVS network, system, and method may include a central system or central application servers in bi-directional communication with one or more oil change and/or service centers, user terminals or user computing devices, administrator portal, and one or more third party databases and/or sources.

Here, the Automated Vehicle Service (AVS) network, system, and method can include a stand-alone application which provides registered users of the AVS network, among others: various recommendations for oil type and filter, brake change, direct users to the AVS, send service reminders, direct users to third party brake mechanic service centers and schedule appointments via the application, provide tire recommendation (if needed) and direct user to third party tire service centers and schedule appointments via the app. In addition, the AVS network may also be connected or associated with a specific third-party mechanic, service center, and/or tire shop chain to further streamline scheduling, recommendations, inventory check, appointment scheduling, and discounts, among others.

One main advantage of the AVS system, is the speed of the oil change process and tire specification recording, oil analysis, brake analysis, fluid refills, which can occur simultaneously. Accordingly, it is contemplated within the scope of the disclosure described herein that the vehicle service may be performed within or about 90 seconds.

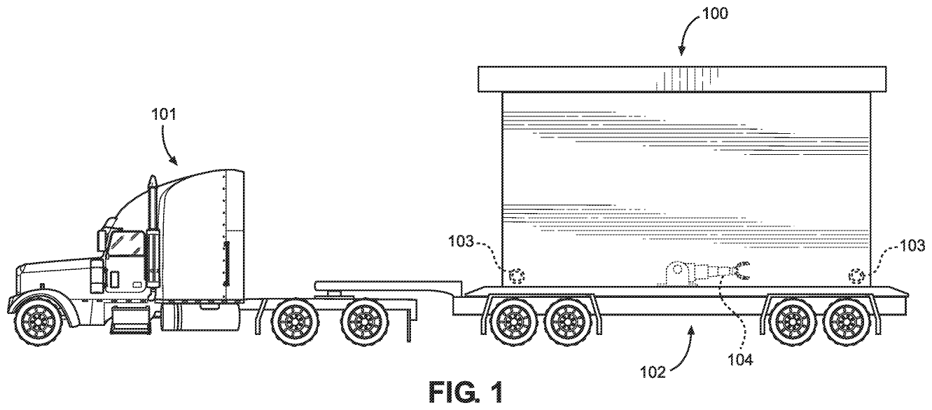

FIG. 1 illustrates a front view of one non-limiting embodiment of the Automated Vehicle Service (AVS) system 100 of the disclosure described herein, of which is loaded onto a flatbed trailer 102 of a semi-truck 101 for rapid deployment and/or relocation. In one embodiment of an oil change/vehicle service stall or bay of the AVS may comprise of a portable or module unit 100, such as one built into a tractor trailer or standard shipping container, that can allow the AVS to easily relocate and go onsite to a customer location. Alternatively, the AVS service stall may be a fixed unit or dwelling having multiple bays with a drive through design. In addition the AVS system may include one or more robotic controlled arms 104 along with various cameras/sensors 103 located around the service stall or bay.

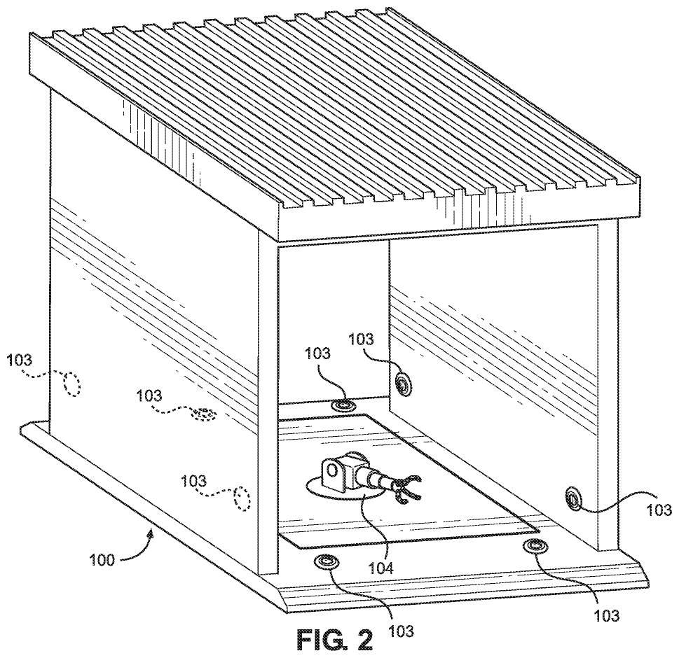

FIG. 2 illustrates a perspective view of one non-limiting embodiment of the Automated Vehicle Service (AVS) system 100 of the disclosure described herein. Here the AVS system 100 includes a drive through design to allow vehicles to drive into, stop and drive out of the stall or bay after completion of the service. In addition, the AVS system 100 may include one or more robot or robotic controlled arms 104 on the floor of the stall or bay, hence allowing access to the undercarriage of a vehicle. In addition, one or more cameras/sensors 103 are placed around the stall or bay, hence allowing a view point of the vehicle tires, undercarriage and other pertinent areas.

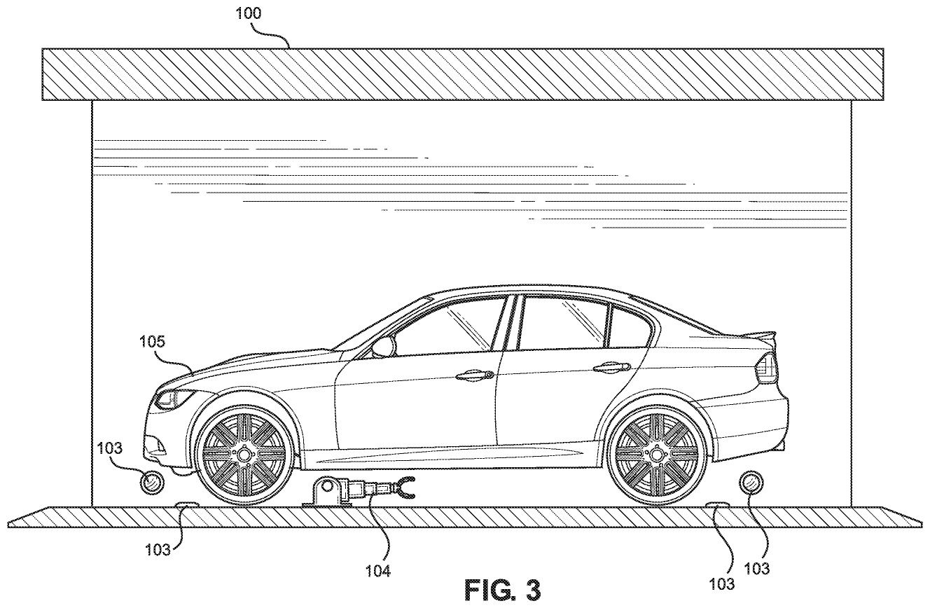

FIG. 3 illustrates a sectional view of one non-limiting embodiment of the Automated Vehicle Service (AVS) system of the disclosure described herein. Here, a vehicle 105 can be seen inside the AVS system 100 stall or bay. In addition, the robotic arm 104 can be seen located under the vehicle 105 in order to gain access to the undercarriage. The cameras/sensors 103 can be seen located across each wheel/tire and beneath the vehicle 105.

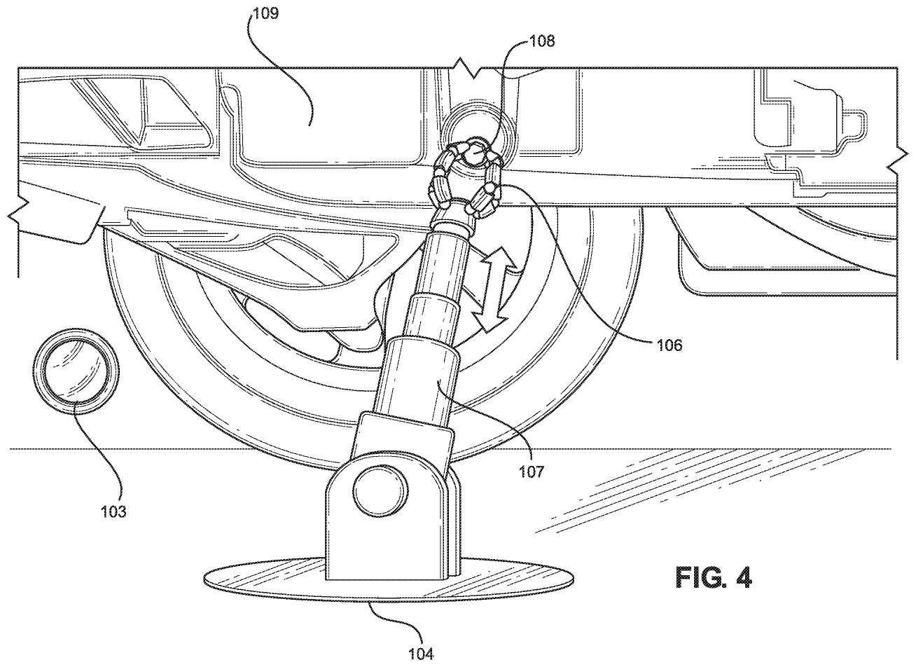

FIG. 4 illustrates a sectional view of one non-limiting embodiment of the Automated Vehicle Service (AVS) system of the disclosure described herein. Here, the sectional view is of the undercarriage of the vehicle 109, wherein the robotic arm 104 is telescoping 107 up to reach the undercarriage 109 and the claw 106 has affixed to the drain plug 108 for removal and replacement with a proprietary plug of the AVS system. This proprietary plug of the AVS system may be a two-way valve, which can allow oil (or other fluids) to be pumped out and pumped into the vehicle with automation. In addition, the robotic arm 104 may also connect to the proprietary valve to pump out used oil and pump in new oil (or other fluids). Also, the robotic arm 104 may also locate, remove and replace the oil filter by using the claw 106.

In one method of operation of the AVS system, the old/used oil (or other fluids) can be captured and a computer running an application can perform a quick diagnostic, and analysis and further record/collect data with respect to the amount of old/used oil, metal and other particle count, and other necessary tests, among other data or information. Here, the collected data can then be added to a vehicle profile within the AVS network and an oil type and other recommendations can be provided to the user of the AVS network for the next oil change based on analysis results and/or prior history.

In another method of operation of the AVS system 100, one or more high resolution cameras and/or photo/video capturing systems 103 may be used to capture the oil change and/or service process under a user's vehicle. For example, such collected photo/video-based information may be used for insurance related claims or legal related purposes. In particular, the foregoing cameras 103 may be used to capture the underside or under carriage (or around) of a vehicle to detect any potential leak of fluids or abnormality, such as via infrared imaging or other methods. Further, the cameras 103 may also capture and record various tire sizes and specifications (such as from reading the sidewalls of the tires) and further transfer the data to the vehicle's profile. In addition, the cameras 103 may also capture other tire related data, such as tread wear, punctures, tire sidewall bubbles, or other related anomalies. The foregoing collected tire information may then be added to the vehicle's 105 profile and various recommendations/notifications may then be provided to the user, which may include, among others, tire air pressure, tire rotation, and tread life.

In addition, the AVS camera system 103 may also include x-ray or infrared technology to capture and view the thickness of brake pads, wherein an application of the AVS system 100 may determine remaining brake pad life, without having to remove a wheel to check such status of the brake pads. Further, the aforementioned robotic arms 104 of the AVS system may also add or remove air pressure from the tires. In addition, the robotic arms 104, which may also be positioned around the perimeter and/or above the vehicle may also add other fluids, such as windshield washer fluid, transmission fluid, cooling/radiator fluid, among other types of fluids. Accordingly, the AVS may include a retrofitted proprietary fluid reservoir cap adapter of the AVS that having the ability to connect lines from existing reservoirs down to below the car, such as where the vehicle's oil drain plug is located, such that fluid can be pumped into the reservoirs for replenishment, or out of for removal.

In another embodiment the AVS system may include one or more robot or robotic controlled arms 104 around each vehicle (including around and above) that are automatically programmed to locate, remove and replace the brake pads (on a variety of vehicles). Accordingly, the AVS may include a retrofitted proprietary brake caliper and/or brake pads with embedded sensors of the AVS where the brake function and remaining life data is electronically transmitted to the network of the AVS system.

In another method of operation of the AVS system and one or more floor sensors may be used to capture tire tread, treadwear, abnormalities and imperfections. The foregoing collected tire information may then be added to the vehicle's profile and various recommendations/notifications may then be provided to the user, which may include, among others, tire air pressure, tire rotation, and tread life.

In another embodiment the AVS system may include one or more robot or robotic controlled arms 104 around the vehicle 105 (including around and above) that are automatically programmed to locate, remove and rotate the wheels (on a variety of vehicles) based on the automatically recommended placement gathered from the collected tire information.

In addition, the AVS network may include an application that allows a user to add their vehicle type and details in AVS system. Here, the application can allow the user to locate multiple AVS systems and current wait times. The application also allows a user to manage their vehicle's oil change and/or servicing via the AVS system. Here, the application can allow the user to automatically make payments via the application, schedule appointments, receive notifications, reminders, messaging capability, and the like. The foregoing vehicle data can then be transferred to other parties in the event of vehicle sale or insurance requirements.

From the foregoing it will be seen that the present disclosure described herein is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts described herein, except insofar as such limitations are included in following claims. Further, it will be understood that certain features and sub-combinations are of utility and may be employed without reference to other features and sub-combinations. This is contemplated by and is within the scope of the claims

What is claimed is:

1. An automated vehicle service system, comprising:
a vehicle service stall; and
one or more robotic arms in or around the stall, wherein the robotic arms are configured to replace a vehicle's oil, other fluids, or other components.

2. The automated vehicle service system of claim 1, wherein
one or more fluid capturing systems in or around the stall, wherein the systems are configured to capture and record fluid data and specifications.

3. The automated vehicle service system of claim 1, wherein
one or more high resolution cameras or photo/video capturing systems in or around the stall, wherein the cameras or photo/video capturing systems are configured to capture and record tire size and specifications.

4. The automated vehicle service system of claim 1, wherein
one or more floor sensors systems in or around the stall, wherein the floor sensor systems are configured to capture tire tread, treadwear, abnormalities and imperfections.

5. The automated vehicle service system of claim 1, wherein
one or more x-ray or infrared technology systems in or around the stall, wherein the x-ray or infrared technology systems are configured to capture and view the thickness and other aspects of brake pads.

6. An automated vehicle service method, comprising:
receiving a vehicle with a vehicle service stall;
operating one or more robotic arms in or around the stall, wherein the robotic arms are configured to replace a vehicle's oil, other fluids, or other components; and
managing said automated vehicle service method via a network.

7. The automated vehicle service method of claim 6, comprising:
receiving a vehicle with a vehicle service stall;
operating one or more fluid capturing devices in or around the stall, wherein the fluid capturing devices are configured to capture and record a vehicle's oil, other fluids, or other components; and
managing said automated vehicle service method via a network.

8. The automated vehicle service method of claim 6, comprising:
receiving a vehicle with a vehicle service stall;
operating one or more high resolution cameras or photo/video capturing systems in or around the stall, wherein the cameras or photo/video capturing systems are configured to capture and record tire size and specifications; and
managing said automated vehicle service method via a network.

9. The automated vehicle service method of claim 6, comprising:
receiving a vehicle with a vehicle service stall;
operating one or more floor sensor systems in or around the stall, wherein the floor sensor systems are configured to capture tire tread, treadwear, abnormalities and imperfections; and
managing said automated vehicle service method via a network.

10. The automated vehicle service method of claim 6, comprising:
receiving a vehicle with a vehicle service stall;
operating one or more x-ray or infrared technology systems in or around the stall, wherein the x-ray or infrared technology systems are configured to capture and view the thickness and other aspects of brake pads; and
managing said automated vehicle service method via a network.
